(19) United States
(12) Patent Application Publication
(10) Pub. No.: US 2026/0180088 A1
(43) Pub. Date: Jun. 25, 2026

(54) SECONDARY BATTERY AND BATTERY PACK INCLUDING THE SAME

(71) Applicant: LG ENERGY SOLUTION, LTD., Seoul (KR)

(72) Inventors: Ji Eun CHOI, Daejeon (KR); Min Kyu LEE, Daejeon (KR); Jae Ho LEE, Daejeon (KR); Ji Sun LEE, Daejeon (KR); Sang Hun KIM, Daejeon (KR)

(21) Appl. No.: 19/425,448

(22) Filed: Dec. 18, 2025

(30) Foreign Application Priority Data
Dec. 20, 2024 (KR) 10-2024-0192946
Dec. 16, 2025 (KR) 10-2025-0200883

(51) Int. Cl. H01M 50/15; H01M 50/103; H01M 50/193; H01M 50/548

(52) U.S. Cl. CPC H01M 50/15; H01M 50/103; H01M 50/193; H01M 50/548

(57) ABSTRACT

A secondary battery that includes an electrode assembly extending in one direction; an exterior film surrounding a portion of the electrode assembly; and a cap surrounding a remaining portion of the electrode assembly. The cap includes a cover covering one side in an extending direction of the electrode assembly; a connector provided on an outer surface of the cover and including coupling portions coupled with the exterior film; and a terminal at least partially exposed to an outside of the cover and electrically connected to the electrode assembly. A corner edge is formed in a rounded manner at a junction where the plurality of coupling portions of the connector meet. The corner edge has a radius of curvature Rg of about 0.1 mm to 1.5 mm, and include a first layer including a first resin that has an outer surface and an inner surface.

### CROSS-REFERENCE TO RELATED APPLICATIONS

This application is based on and claims priorities from Korean Patent Application No. 10-2024-0192946 filed on Dec. 20, 2024, and Korean Patent Application No. 10-2025-0200883 filed on Dec. 16, 2025, each filed with the Korean Intellectual Property Office, the disclosures of which is incorporated herein in its entirety by reference.

### TECHNICAL FIELD

The present disclosure relates to a secondary battery and a battery pack including the same.

### BACKGROUND

In recent years, as the price of energy resources increases caused by depletion of fossil fuels and the interest regarding environmental pollution is amplified, demands for environment-friendly alternative energy sources have become indispensable factors for future life. Accordingly, research on various power generation technologies such as solar power, wind power, and tidal power has continued, and significant attention has also been directed to power storage devices such as batteries that are used to more efficiently utilize electric energy generated in this manner.

Furthermore, as technological development and demand for electronic mobile devices and electric vehicles employing batteries have increased, demand for batteries as energy sources has rapidly increased, and therefore extensive researches on batteries capable of meeting various requirements are being carried out.

Batteries that store electric energy may generally be classified into primary batteries and secondary batteries. The primary batteries are disposable and consumable batteries, whereas the secondary batteries are rechargeable batteries manufactured using materials that allow repeated oxidation and reduction reactions between current and material. For example, in the secondary batteries, when a reduction reaction with respect to the material is performed by a current, the battery is charged, and when an oxidation reaction with respect to the material is performed, the battery is discharged, and electric power is generated as charging and discharging are repeatedly performed.

### SUMMARY

Embodiments of the present disclosure provide a secondary battery that has improved battery capacity while having fewer restrictions with respect to shape, reduces an amount of moisture introduced from outside, and exhibits improved structural stability.

Embodiments of the present disclosure provide a secondary battery with improved safety by controlling a direction in which gas or flame generated inside the secondary battery may be discharged.

Embodiments of the present disclosure provide a secondary battery having excellent airtightness and durability without an unsealed portion at a corner edge by controlling a radius of curvature of the corner edge during sealing between a connector and an exterior film and by applying a resin having melt flow characteristics suitable for sealing.

[1] In one aspect, a secondary battery includes: an electrode assembly extending in one direction; an exterior film surrounding a portion of the electrode assembly; and a cap surrounding a remaining portion of the electrode assembly, in which the cap includes: a cover covering one side in an extending direction of the electrode assembly; a connector provided on an outer surface of the cover and including a plurality of coupling portions that are coupled with the exterior film; and a terminal at least partially exposed to an outside of the cover and electrically connected to the electrode assembly, a corner edge is formed in a rounded manner at a junction where the plurality of coupling portions meet, the corner edge has a radius of curvature Rg of about 0.1 mm to 1.5 mm, and include a first layer including a first resin that has an outer surface allowing coupling with an inner surface of the exterior film and an inner surface allowing coupling with the outer surface of the cover, and the first resin includes a resin having a melt flow rate (MFR) at 230° C. of about 4 g/10 min to 14 g/10 min.

[2] In the secondary battery according to [1], the first resin may include a resin selected from resins having a melting point (Tₘ) of about 135° C. to 150° C. and a melt flow rate (MFR) at 230° C. of about 4 g/10 min to 14 g/10 min.

[3] In the secondary battery according to [1] or [2], the first resin may include a modified polyolefin-based resin.

[4] In the secondary battery according to at least one of [1] to [3], each of the plurality of coupling portions of the connector may include: a first layer including the first resin and allowing coupling with an outer surface of the cover; and a second layer including a second resin stacked on an outer surface of the first layer and allowing coupling with the inner surface of the exterior film.

[5] In the secondary battery according to [4], the second resin may include at least one selected from a resin having a melting point (Tₘ) of about 120° C. to 145° C.; a resin having a melt flow rate (MFR) at 230° C. of about 5 g/10 min to 18 g/10 min; and a resin having both a melting point (Tₘ) of about 120° C. to 145° C. and a melt flow rate (MFR) at 230° C. of about 5 g/10 min to 18 g/10 min.

[6] In the secondary battery according to at least one of [1] to [5], wherein the first resin and the second resin satisfy at least one of Formulas 1 and 2 below:

$${T}_{m 2} > {T}_{m 1} \qquad [ Formula 1 ]$$

where Tₘ₁ is a melting point of the first resin, and Tₘ₂ is a melting point of the second resin, in ° C.;

$$MFR 2 > MFR 1 \qquad [ Formula 2 ]$$

where MFR1 is a melt flow rate of the first resin, and MFR2 is a melt flow rate of the second resin, in g/10 min.

[7] In the secondary battery according to at least one of [4] to [6], the first resin may include a modified polyolefin-based resin, and the second resin may include an unoriented polyolefin-based resin.

[8] In the secondary battery according to at least one of [1] to [7], an outer circumferential surface of the cover may extend in a circumferential direction of the electrode assembly, and the plurality of coupling portions may be provided on the outer circumferential surface of the cover.

[9] In the secondary battery according to at least one of [1] to [8], the cover may include a cover portion having an outward-facing surface facing an outside of the electrode assembly; and an extension portion extending toward the electrode assembly from the cover portion, and the plurality of coupling portions may be provided on an outer surface of the extension portion.

[10] In the secondary battery according to [9], the cover portion may have a plate shape, and the extension portion may extend from an edge of the cover.

[11] In the secondary battery according to [9], a radius of curvature of a cover edge formed at a position corresponding to the corner edge in the cover portion may be less than or equal to the radius of curvature of the corner edge.

[12] In the secondary battery according to at least one of [1] to [11], the exterior film may have a predetermined flexibility to allow bending.

[13] In the secondary battery according to [1] to [12], the connector may include a connecting portion provided on at least one surface of the outer surface of the cover, excluding the outer surface of the cover portion on which the plurality of coupling portions are provided.

[14] In the secondary battery according to [13], the connecting portion of the connector may include a first layer including the first resin and having an outer surface allowing coupling with the inner surface of the exterior film and an inner surface allowing coupling with the outer surface of the cover portion.

[15] In the secondary battery according to at least one of [13] to [14], the connecting portion of the connector may include: a first layer including the first resin and allowing coupling with an outer surface of the cover; and a second layer including a second resin stacked on an outer surface of the first layer and allowing coupling with the inner surface of the exterior film.

[16] In another aspect, a battery pack includes: a secondary battery; and a packaging configured to accommodate the secondary battery, in which the secondary battery includes: an electrode assembly extending in one direction; an exterior film surrounding a portion of the electrode assembly; and a cap surrounding a remaining portion of the electrode assembly, the cap includes: a cover covering one side in an extending direction of the electrode assembly; a connector including a coupling portion provided on an outer surface of the cover and coupled with the exterior film; and a terminal at least partially exposed to an outside of the cover and electrically connected to the electrode assembly, a corner edge is formed in a rounded manner at a junction where the plurality of coupling portions of the connector meet, and the corner edge has a radius of curvature Rg of about 0.1 mm to 1.5 mm.

The secondary battery according to an embodiment of the present disclosure does not require a process of molding the exterior film, thereby reducing restrictions on a shape of the exterior film configured to accommodate the electrode assembly, reducing a possibility that defects such as cracks occur in the exterior film, and enabling improvement in battery capacity.

The secondary battery according to an embodiment of the present disclosure may improve safety of the secondary battery by reducing a degree to which moisture or the like penetrates into the secondary battery from outside of the secondary battery.

The secondary battery according to an embodiment of the present disclosure may improve durability of the secondary battery because the secondary battery has excellent sealing strength, excellent airtightness, and enhanced rigidity, and may withstand an internal pressure caused by gas generated inside the secondary battery to a high level.

In the secondary battery according to an embodiment of the present disclosure, a terminal and a bus bar may be electrically connected to the electrode assembly in various forms.

The secondary battery according to an embodiment of the present disclosure may improve structural stability of the secondary battery by a coupling relationship and arrangement structure between a connector and a cover, and may control a problem in which venting is directed toward a cap portion in a situation of explosive increase of internal pressure or flame discharge through structural stability.

The secondary battery according to an embodiment of the present disclosure may be electrically connected to the outside efficiently by the terminal portion penetrating the connector.

The secondary battery according to an embodiment of the present disclosure may protect a cover portion of the cover from external contamination or impact by an outer portion of the connector.

The secondary battery according to an embodiment of the present disclosure may improve coupling performance between the connector and the cover because the outer portion and a coupling portion of the connector are coupled with each other.

The secondary battery according to an embodiment of the present disclosure may improve insulation between the cover and another component since the cover is covered by the outer portion, and may suppress heat transfer during a thermal runaway situation.

The secondary battery according to an embodiment of the present disclosure may enable the cap to be easily manufactured by an insert injection process since the cover portion is entirely surrounded by the connection portion.

Effects according to the present disclosure are not limited to the above-described examples, and more various effects are included within the present specification.

### BRIEF DESCRIPTION OF THE DRAWINGS

The following drawings attached hereto illustrate embodiments of the present disclosure and serve to further understand the technical idea of the present disclosure together with the detailed description of the disclosure to be described later. Therefore, the present disclosure should not be construed as being limited to the matters illustrated in the drawings.

FIG. 1 is a perspective view of a battery pack according to an embodiment of the present disclosure as viewed from above. In this case, a packaging is indicated by a dotted line, and components visible through the packaging are indicated by solid lines.

FIG. 2 is a perspective view of a secondary battery according to a first embodiment of the present specification as viewed from above.

FIG. 3 is an exploded perspective view of the secondary battery illustrated in FIG. 2.

FIG. 4 is an exploded perspective view illustrating a state where a connector and a cover are coupled in FIG. 3.

FIG. 5 is a partial sectional view taken along line A-A′ of FIG. 2.

FIG. 6 is a partial sectional view taken along line B-B′ of FIG. 2.

FIG. 7 is a perspective view of a secondary battery according to a first embodiment of the present specification as viewed from above.

FIG. 8 is an exploded perspective view of the secondary battery illustrated in FIG. 7.

FIG. 9 is a partial sectional view taken along line C-C′ of FIG. 7.

FIG. 10 is a partial sectional view taken along line C-C′ of FIG. 7 of a secondary battery according to a third embodiment of the present specification.

FIG. 11 is a perspective view illustrating sealing surfaces of an exterior film and a connector sealed by a four-sided vertical sealing device.

FIG. 12 is a perspective view illustrating sealing surfaces of an exterior film and a connector sealed by a corner-type sealing device.

FIG. 13 is a partial sectional view taken along line C-C′ of FIG. 7 of a secondary battery according to a fourth embodiment of the present disclosure (first modification of the coupling portion).

FIG. 14 illustrates a partial sectional view taken along line C-C′ of FIG. 7 of a secondary battery according to a fourth embodiment of the present disclosure (second modification of the coupling portion).

FIG. 15 illustrates a partial sectional view taken along line C-C′ of FIG. 7 of a secondary battery according to a fourth embodiment of the present disclosure (third modification of the coupling portion).

Corresponding reference characters indicate corresponding components throughout the several views of the drawings. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Advantages and features of the secondary battery described in the present specification and methods for achieving those will become apparent with reference to embodiments described in detail below together with the accompanying drawings. However, the secondary battery described in the present specification is not limited to the embodiments disclosed below but may be implemented in various different forms, and the embodiments are provided to fully disclose the present invention and to fully inform those skilled in the art to which the invention pertains of the scope of the invention, and the present invention is defined only by the scope of the claims. Throughout the specification, like reference numerals refer to like components.

Unless otherwise defined, all terms used herein, including technical and scientific terms, may be understood in a meaning commonly understood by those skilled in the art. In addition, terms defined in generally used dictionaries are not interpreted ideally or excessively unless explicitly specially defined.

Terms used in the present specification are intended to describe embodiments and are not intended to limit the disclosure relating to the secondary battery described in the present specification. As used herein, the singular forms include the plural forms unless the context clearly indicates otherwise. The terms “comprises” and/or “comprising” used in the specification do not exclude the presence or addition of one or more other components in addition to the components mentioned.

Through the specification, when a part is said to “include” a component, this does not exclude other components, but rather includes other components, unless otherwise specifically stated.

In the present specification, the expression “A and/or B” means A, or B, or both A and B.

As used herein, the terms “about”, “approximately”, “substantially” refer to a range of, or approximation to a numerical value or degree, taking into account inherent manufacturing and material tolerances (e.g., ±5%)

Secondary batteries may be classified into cylindrical cells, pouch cells, prismatic cells, and the like, depending on their form. Among them, in a pouch cell, an electrode assembly having a stacked structure of a positive electrode, a negative electrode, and a separator is accommodated inside a pouch, and the pouch may be manufactured with its outer portion sealed.

Conventional pouch cells have a problem in that cracks occur in a pouch film during a forming process of the pouch film, and many pouch films are discarded after a degassing process. In addition, a forming depth may be limited depending on material characteristics of the pouch film, and therefore an increase in battery capacity has a limit. Furthermore, in conventional pouch cells, since upper and lower cases are cup-formed using a pouch film and a cell is configured by sealing outer portions of the two cases facing each other, there is also a problem in that limitations exist in controlling or predicting a venting direction in a situation in which internal pressure of the cell increases or an explosion occurs due to abnormal operation of the cell.

The present disclosure provides a secondary battery having a structure in which restrictions on shape are relatively small and battery capacity may be improved, and further provides a secondary battery capable of controlling a discharge direction when gas is discharged or flame occurs inside the cell.

Hereinafter, the secondary battery described in the present specification will be described in detail.

The secondary battery according to the present specification includes at least one of the components described below and may include any combination among technically available ones of the following components.

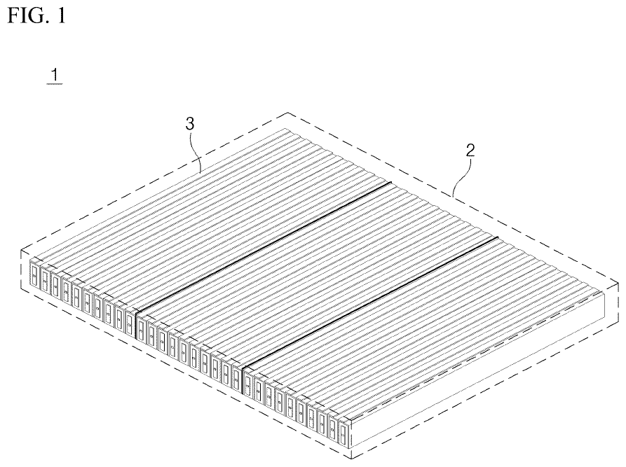

FIG. 1 is a perspective view of a battery pack according to an embodiment of the present disclosure as viewed from above. In this case, a packaging is indicated by a dotted line, and components visible through the packaging are indicated by solid lines.

FIG. 1 illustrates a battery pack according to an embodiment of the present disclosure. Referring to FIG. 1, a battery pack 1 according to an embodiment of the present disclosure may be a battery pack configured to charge and discharge electrical energy.

The battery pack 1 according to an embodiment of the present disclosure may include a secondary battery 3. In this case, the secondary battery 3 may be configured as a plurality. In the meantime, the battery pack 1 may include a packaging 2 that accommodates the plurality of secondary batteries 3 therein. The packaging 2 may be configured to protect the secondary battery 3 from external impact or contamination.

In the present embodiment, the packaging 2 may be provided as a box-shaped structure. The packaging 2 may be made of metal or plastic having a predetermined rigidity. The packaging 2 may have a structure in which a plurality of plates are coupled.

However, a shape or structure of the packaging 2 may be modified as needed. For example, at least a portion of the packaging 2 may have a curved shape. In addition, other components may be additionally provided in the packaging 2. For example, the packaging 2 may include a busbar electrically connected to the plurality of secondary batteries 3 and/or a venting component configured to communicate between an inner portion and an outer portion of the packaging 2.

Hereinafter, the secondary battery according to an embodiment of the present disclosure will be described.

### Embodiment 1

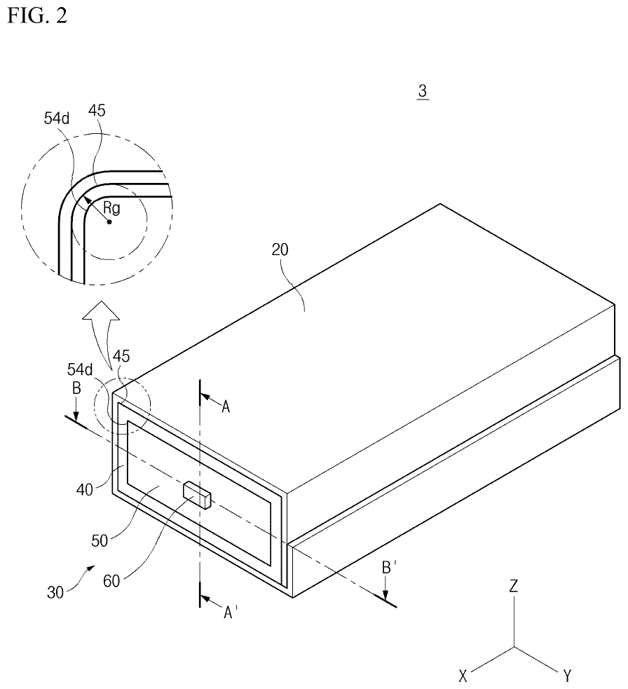

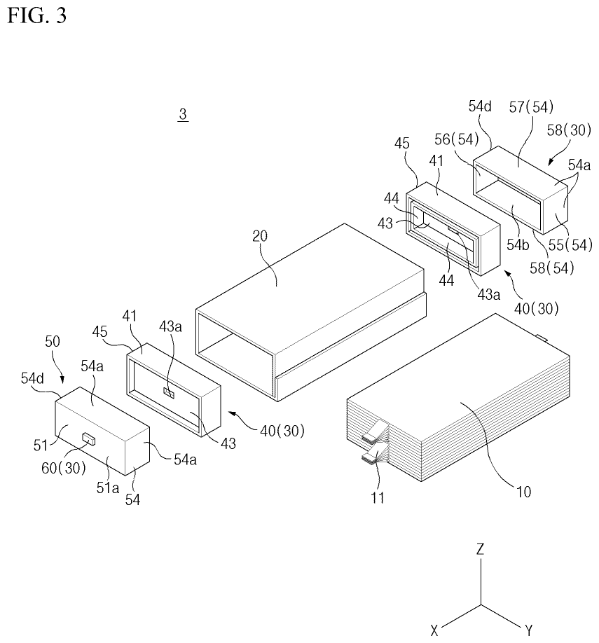

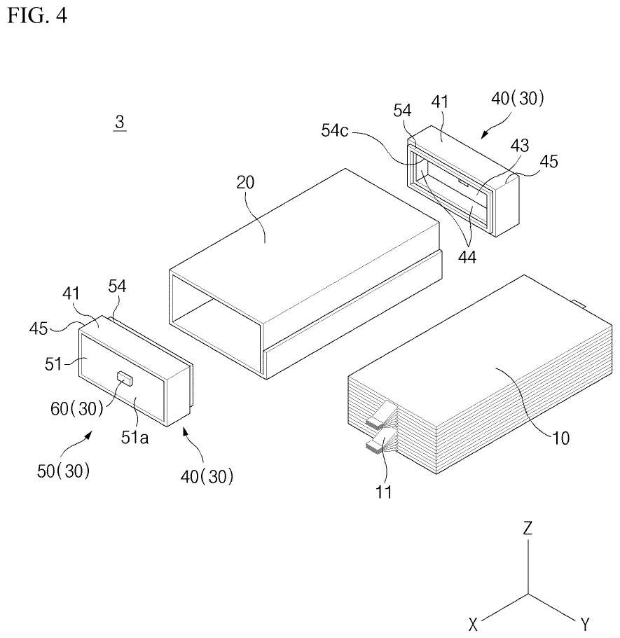

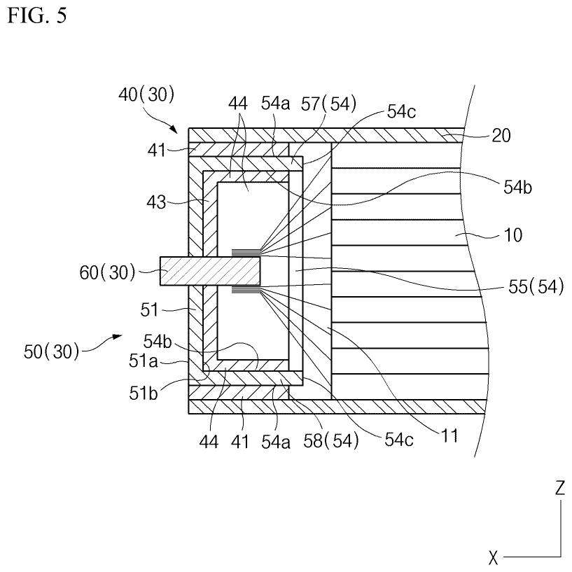

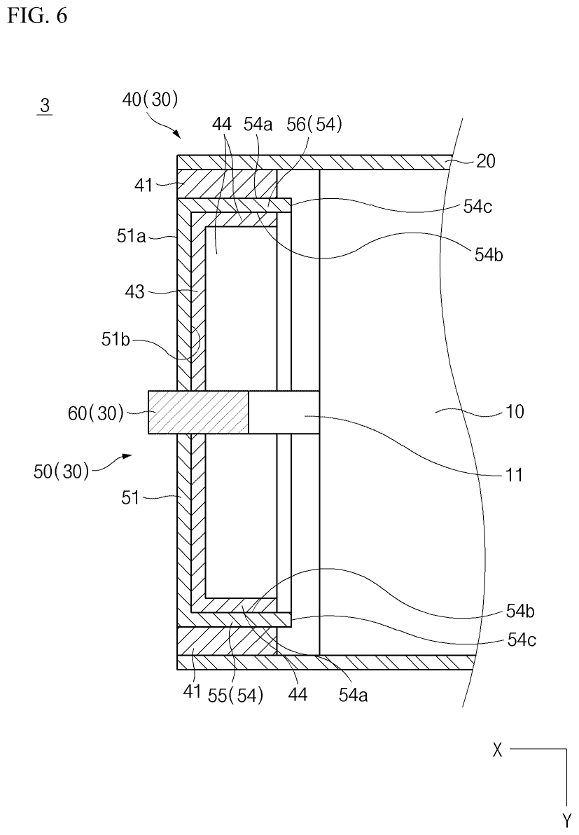

FIG. 2 is a perspective view of a secondary battery according to a first embodiment of the present disclosure as viewed from above. FIG. 3 is an exploded perspective view of the secondary battery illustrated in FIG. 2. FIG. 4 is an exploded perspective view illustrating a state where a connector and a cover are coupled in FIG. 3. FIG. 5 is a partial sectional view taken along line A-A′ of FIG. 2. FIG. 6 is a partial sectional view taken along line B-B′ of FIG. 2.

Referring to FIGS. 2 to 6, the secondary battery 3 according to the first embodiment of the present disclosure may include an electrode assembly 10, an exterior film 20, and a cap 30. Hereinafter, each component of the secondary battery 3 will be described in more detail. For reference, content relating to the first embodiment may also be applied to other embodiments described below unless mutually inconsistent.

### Electrode Assembly

An electrode assembly 10 of the secondary battery 3 may include a positive electrode, a negative electrode, and a separator. Here, the separator may be disposed between the positive electrode and the negative electrode to physically separate the positive electrode and the negative electrode. The electrode assembly 10 may have a stacked structure in which the positive electrode, the negative electrode, and the separator are stacked, or may have a jelly-roll structure in which the positive electrode, the negative electrode, and the separator are wound. A type or structure of the electrode assembly 10 is not particularly limited. The electrode assembly 10 may extend in one direction (e.g., X-axis direction) to have a predetermined length.

In the meantime, the electrode assembly 10 may include an electrode tab 11 connected to the electrode. The electrode tab 11 may be provided separately or may be provided as a portion of a current collector constituting the electrode. For reference, when the electrode assembly 10 is an all-solid-state battery, a solid electrolyte may be provided instead of the separator.

### Exterior Film

Referring to FIGS. 1 to 6, the secondary battery 3 according to the first embodiment of the present disclosure may include an exterior film 20. The exterior film 20 of the secondary battery 3 may be provided to surround a portion of the electrode assembly 10. For example, the exterior film 20 may be provided to surround the electrode assembly 10 together with a cap 30 described below. In one embodiment, the exterior film 20 may be coupled with the cap 30 to form an internal space, and the electrode assembly 10 may be accommodated in the formed internal space.

As illustrated, in the present embodiment, the exterior film 20 may surround the electrode assembly 10 in a circumferential direction. The circumferential direction may be a direction surrounding an axis (e.g., X-axis) parallel to an extending direction of the electrode assembly 10. The exterior film 20 may be formed of a material capable of being deformed in shape so as to surround the electrode assembly 10. For example, the exterior film 20 may have predetermined flexibility so as to be bent by an external force.

In addition, the exterior film 20 may be formed of a material having no stretchability. In pouch cells, a pouch film is formed to define a space for accommodating the electrode assembly. However, the exterior film 20 does not need to be reshaped through forming, and therefore may be formed of a material having no stretchability. However, the exterior film 20 may have predetermined stretchability when necessary.

The exterior film 20 of the secondary battery 3 may have a rolled shape in which a sheet or film is wound along side surfaces of the electrode assembly 10. For example, the exterior film 20 may be disposed in a manner surrounding side portions of the electrode assembly 10. In this case, one end and the other end of the exterior film 20 may meet each other to surround the electrode assembly 10. In relation to a manner in which one end and the other end of the exterior film 20 meet each other, one surface of the one end and the other surface of the other end may be coupled with each other while overlapping (see, e.g., FIG. 2). However, this is merely an example, and various forms of coupling between the one end and the other end of the exterior film 20 may be used to form a space accommodating the electrode assembly 10.

In relation to a method of coupling one end and the other end of the exterior film 20, the one end and the other end of the exterior film 20 may be coupled with each other by heat sealing or heat and pressure sealing. For example, the exterior film 20 may include a material having heat sealability.

As an example of a structure of the exterior film 20, the exterior film 20 may be formed in a film shape. For example, the exterior film 20 may include a plurality of layers including a sealant layer, a barrier layer, and an insulating layer. In one embodiment, the exterior film 20 may be arranged in the order of the sealant layer, the barrier layer, and the insulating layer from an inner side close to the electrode assembly 10.

In one embodiment, the sealant layer may include a material having heat sealability so that one end and the other end of the exterior film 20 may be coupled with each other. For example, the sealant layer of the exterior film 20 may include one or more materials selected from polyethylene, polypropylene, polycarbonate, polyethylene terephthalate, polyvinyl chloride, acrylic polymer, polyacrylonitrile, polyimide, polyamide, cellulose, aramid, nylon, polyester, polyparaphenylene benzobisoxazole, polyarylate, Teflon, and glass fiber. Mainly, a polyolefin-based resin such as polypropylene (PP) or polyethylene (PE) may be used. Polypropylene (PP) may exhibit excellent mechanical properties such as tensile strength, rigidity, surface hardness, wear resistance, and heat resistance, and chemical properties such as corrosion resistance.

The barrier layer may include a metal. For example, the metal of the barrier layer may include one or more materials selected from iron (Fe), carbon (C), chromium (Cr), manganese (Mn), nickel (Ni), and aluminum (Al). As an example, the barrier layer may include stainless steel (STS). In addition, the barrier layer may be formed of an alloy such as an aluminum alloy.

The insulating layer may include an insulating material. The electrode assembly 10 may be insulated from the outside by the insulating layer. Therefore, the insulating layer may prevent or suppress short-circuiting of the exterior film 20. For example, the insulating layer may include one or more materials selected from polyethylene, polypropylene, polycarbonate, polyethylene terephthalate, polyvinyl chloride, acrylic polymer, polyacrylonitrile, polyimide, polyamide, cellulose, aramid, nylon, polyester, polyparaphenylene benzobisoxazole, polyarylate, Teflon, and glass fiber. Mainly, a polymer such as nylon resin having wear resistance and heat resistance or polyethylene terephthalate (PET) may be used.

In the meantime, the exterior film 20 may be arranged so as to surround a portion of the electrode assembly 10, and the cap 30 may be arranged so as to surround the remaining portion of the electrode assembly 10. For example, when the exterior film 20 is arranged so as to surround the electrode assembly 10 along side surfaces (or an outer circumferential surface) of the electrode assembly 10, an opening configured of an edge of the exterior film 20 may be formed at both ends of the electrode assembly 10. In this case, the openings may be located on both sides in an extending direction (e.g., X-axis direction) of the electrode assembly 10.

The cap 30 of the secondary battery 3 may be coupled with the exterior film 20 in a form covering the openings on both sides of the electrode assembly 10. In addition, the electrode assembly 10 may be accommodated in an internal space formed by the exterior film 20 and the cap 30.

The exterior film 20 may be coupled with the cap 30. As an example of a coupling method between the cap 30 and the exterior film 20, the cap 30 and the exterior film 20 may be coupled by welding. For example, a connector 40 described below may include a metal material, and the exterior film 20 may include a metal layer capable of being welded to the connector 40 in a portion facing the connector 40.

As another example of a coupling method between the cap 30 and the exterior film 20, the cap 30 and the exterior film 20 may be coupled by sealing. For example, the connector 40 may include a resin material having adhesiveness by heat, and the exterior film 20 may include a resin layer capable of being coupled with the connector 40 by heat and pressure in a portion facing the connector 40. Here, the resin layer may include a material having heat sealability as described above.

Conventional pouch cells form a cup by forming a sheet or film to accommodate the electrode assembly 10. In a forming process of the cup, a forming depth was limited depending on material characteristics of the sheet or film, and therefore a capacity capable of accommodating the electrode assembly 10 was also limited. In addition, when a sheet or film was formed, the thickness of a corner portion became thinnest, and defects such as cracks frequently occurred. Furthermore, conventional pouch cells required a gas collector for degassing to remove gas accumulated inside the pouch, and a large amount of portions removed and discarded after the degassing process existed.

The secondary battery 3 according to the first embodiment of the present disclosure may not have limitations on a capacity capable of accommodating the electrode assembly 10 since the exterior film 20 may be used so as to correspond to a volume of the electrode assembly 10. In addition, forming of the cup is not required, and thus defects such as cracks occurring in the exterior film 20 may be prevented, and a material or thickness of the exterior film 20 may be relatively freely selected. Furthermore, since an electrolyte injection process and a degassing process may be performed through the cap 30, the exterior film 20 to be discarded may not occur, and economic efficiency of the process may be improved.

### Cap

Referring to FIGS. 2 to 6, the cap 30 of the secondary battery 3 according to the first embodiment of the present disclosure may include a connector 40, a cover 50, and a terminal 60. In the present embodiment, the cap 30 may seal the electrode assembly 10 together with the exterior film 20. As a result, discharge of gas or flame caused by abnormal behavior inside the secondary battery 3 may be guided (or concentrated) toward the exterior film 20, thereby improving safety of the secondary battery 3.

The connector 40 of the cap 30 may be coupled with the exterior film 20. In addition, the cover 50 of the cap 30 may be coupled with the connector 40 and may be provided such that a portion thereof is exposed to the outside of the connector 40. For example, one surface of the cover 50 may be exposed to the outside of the connector 40.

Here, the inner side of the connector 40 may refer to a portion of an internal space formed by the cap 30 and the exterior film 20, and the outer side of the connector 40 may refer to a space outside the cap 30 and the exterior film 20.

In addition, a surface of the cover 50 that is exposed outwardly from the connector 40 may be an outward-facing surface 51a facing outward. The outward-facing surface 51a may be provided on a cover portion 51 of the cover 50 described below. A surface of the cover portion 51 opposite to the outward-facing surface 51a may be referred to as an inward-facing surface 51b. The inward-facing surface 51b may be a surface facing the electrode assembly 10.

Referring to FIGS. 2 to 6, in the present embodiment, the connector 40 may include a coupling portion 41. The coupling portion 41 may be a portion that directly couples the cover 50 and the exterior film 20. If necessary, the coupling portion 41 may be configured as a single layer including one material, a single layer including different materials, a plurality of layers each including different materials, or a plurality of layers each including different materials in respective layers.

In the present embodiment, the coupling portion 41 may be provided on an outer surface 54a of an extension portion 54 of the cover 50. Here, the outer surface 54a of the extension portion 54 may be a surface facing outward (or an outer circumferential surface). The coupling portion 41 may be provided between the extension portion 54 and the exterior film 20 to couple the extension portion 54 and the exterior film 20.

In the present embodiment, the coupling portion 41 may be provided along the outer surface 54a (or the outer circumferential surface) of the extension portion 54. As will be described later, since the extension portion 54 has a ring shape in the present embodiment, the coupling portion 41 may also have a ring shape corresponding to the extension portion 54. In this case, the ring shape may be a shape viewed in a longitudinal direction (e.g., X-axis direction) of the electrode assembly 10. A shape of the coupling portion 41 may be appropriately modified according to a structure of the cover 50.

In addition, in the present embodiment, the connector 40 may include an inner portion 43. The inner portion 43 may be provided on the inner surface 51b of the cover portion 51. The inner portion 43 may entirely cover the inner surface 51b. The inner portion 43 may have a plate shape having a predetermined thickness. Accordingly, heat transfer or moisture penetration through the cover portion 51 may be effectively suppressed. In the meantime, the inner portion 43 may be provided with a terminal hole 43a. The terminal hole 43a may be a hole through which the terminal 60 described below penetrates.

In the meantime, in the present embodiment, the connector 40 may include an extension portion-side portion 44. The extension portion-side portion 44 may be provided on an inner surface 54b (or inner circumferential surface) of the extension portion 54 of the cover 50 described below. Here, the inner surface 54b of the extension portion 54 may be a surface opposite to the outer surface 54a. The inner surface 54b may be a surface facing inward.

In the present embodiment, the extension portion-side portion 44 may be provided along the inner surface 54b (or inner circumferential surface) of the extension portion 54. Since the extension portion 54 also has a ring shape, the extension portion-side portion 44 may also have a ring shape corresponding to the extension portion 54. In this case, the ring shape may be a shape viewed in a lengthwise direction (e.g., X-axis direction) of the electrode assembly 10. A shape of the extension portion-side portion 44 may be appropriately modified according to a structure of the cover 50.

In this case, the extension portion-side portion 44 and the inner portion 43 may be connected to each other. In other words, the extension portion-side portion 44 may extend from the inner portion 43. The extension portion-side portion 44 may extend from an edge portion of the inner portion 43. As a result, reinforcement of rigidity of the cap 30 by the connector 40, suppression of moisture penetration, and suppression of heat transfer may be enhanced.

### Connector

The connector 40 and the corner edge 45 according to an embodiment of the present disclosure will now be described in more detail.

Referring to FIGS. 2 to 11, the connector 40 may include a plurality of coupling portions 41 provided on an outer surface of the cover 50 and coupled with the exterior film 20, and a corner edge 45 may be formed in a rounded manner at a junction where the plurality of coupling portions 41 of the connector 40 meet.

The coupling portion 41 of the connector 40 may be provided on an outer surface 54a of an extension portion 54 of the cover 50, that is, a surface facing outward (or an outer circumferential surface), and a first extension portion 55, a third extension portion 57, a second extension portion 56, and a fourth extension portion 58 may be sequentially connected, and rounded at each junction to form the corner edge 45.

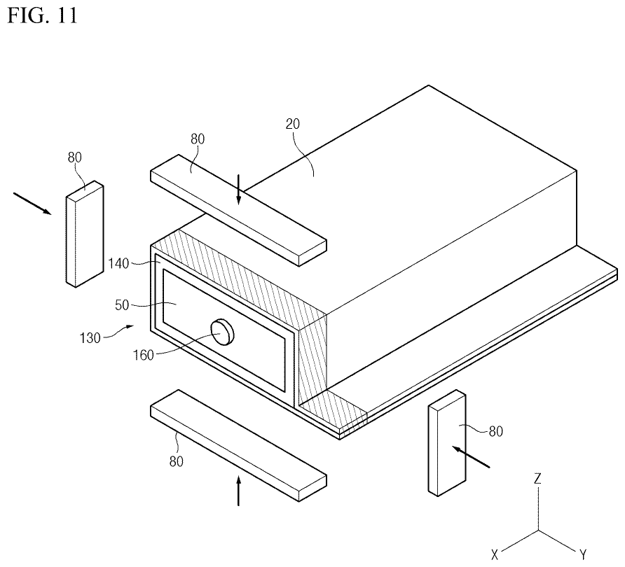

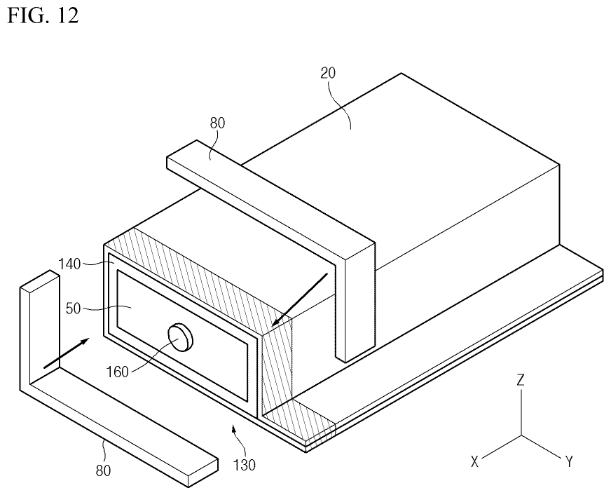

In one embodiment, the corner edge 45 may have a radius of curvature Rg of about 0.1 mm to 1.5 mm as shown in FIG. 2. The connector 40 may serve to improve coupling strength between the cover 50 and the exterior film 20, but airtightness at the corner edge 45 may be problematic. Unlike sealing of conventional pouch-type secondary batteries, in which upper and lower surfaces of a pouch film are overlapped and subjected to heat and pressure, sealing may need to be performed along the plurality of coupling portions 41 of the connector 40 having a three-dimensional shape. For example, as illustrated in FIG. 11, sealing may be performed by heating and pressing four surfaces individually, or as illustrated in FIG. 12, sealing may be performed using a corner-type sealing device having an L-shaped sealing block.

However, depending on the radius of curvature of the corner edge 45, unsealed regions may be generated or the exterior film 20 may be fractured. Therefore, the radius of curvature Rg of the corner edge 45 needs to be controlled within the range of about 0.1 mm to 1.5 mm. Within the above range, fracture probability of the exterior film 20 corresponding to the corner edge 45 may be reduced, and a more excellent sealing structure may be formed, thereby improving airtightness.

The radius of curvature Rg of the corner edge 45 may be in the range of about 0.1 mm to 1.5 mm, and for example, may be about 0.2 mm or more, 0.3 mm or more, 0.4 mm or more, or about 0.5 mm or more, and may also be about 1.4 mm or less, 1.3 mm or less, 1.2 mm or less, 1.1 mm or less, or about 1.0 mm or less. Forming the connector 40 such that the above range is satisfied may sufficiently secure airtightness through sealing with the exterior film 20. In addition, as described above, the radius of curvature Rc of a cover edge 54d of the cover 50 may be less than or equal to the radius of curvature Rg of the corner edge 45.

In the meantime, as one example of a configuration for electrical connection with the outside, the cap 30 of the secondary battery 3 according to the first embodiment of the present disclosure may include a terminal 60. The terminal 60 may penetrate the connector 40 and the cover 50 so as to be exposed to both an outer side and an inner side of the connector 40. A portion of the terminal 60 exposed to the inner side of the connector 40 may be electrically connected to the electrode assembly 10. Here, the electrical connection may include both direct connection between the terminal 60 and the electrode assembly 10 and indirect connection mediated by another electrically conductive member. A portion of the terminal 60 exposed to the outside of the connector 40 may be electrically connected to the outside.

The terminal 60 may include a material having electrical conductivity for electrical connection between the electrode assembly 10 and the exterior. The terminal 60 may be disposed in a shape protruding outward from the connector 40 (see, e.g., FIG. 2). Therefore, the secondary battery 3 may be electrically connected to the outside in various forms and may efficiently provide electric energy to the outside.

The structure of the terminal 60 is described below in more detail. The terminal 60 of the cap 30 according to the first embodiment of the present disclosure may extend from the inside of the connector 40 to the outside of the connector 40. The terminal 60 may be formed to have a constant cross-sectional area in the longitudinal direction. For example, the terminal 60 may have a cylindrical or rectangular-prism shape. Hereinafter, the terminal 60 having a rectangular-prism shape will be described as an example. The terminal 60 having a constant cross-section in the longitudinal direction may provide excellent manufacturability.

The electrode assembly 10 may include electrodes and a separator laminated side by side. In this case, the terminal 60 may have one surface and the other surface formed as planar surfaces at both ends of a portion exposed to the inside of the connector 40, based on the lamination direction of the electrodes and the separator. Referring to FIG. 4, one surface and the other surface formed at both ends of the terminal 60 may be surfaces that contact electrode tabs 11 of the electrode assembly 10. With such a structure, the terminal 60 may be connected to the electrode tabs 11 more efficiently.

In addition, when the secondary battery 3 includes a plurality of electrode assemblies 10, the electrode tabs 11 of the plurality of electrode assemblies 10 may be electrically connected to one surface and the other surface of the terminal 60, respectively. Accordingly, the secondary battery 3 may increase battery capacity efficiently.

The terminal 60 may have various shapes other than the shape described in the first embodiment of the present disclosure for efficient electrical connection. Although not illustrated in detail in the drawings, a gasket may be provided on an outer circumferential portion of the terminal 60. The gasket may serve to prevent leakage of an electrolyte. The gasket may be interposed between the outer circumferential portion of the terminal 60 and the cover 50. The gasket may be formed of a polymer material such as plastic or rubber.

The structure of the cover 50 is described below in more detail.

As one example of a configuration for improving structural stability of the cap 30, the cover 50 of the cap 30 according to the first embodiment of the present disclosure may be embedded at least partially in the connector 40. In connection with this, the cover 50 of the cap 30 may include a cover portion 51 and an extension portion 54.

The cover portion 51 of the cover 50 may be located at one side of the electrode assembly 10 in a longitudinal direction (e.g., X-axis direction). The cover portion 51 may cover the one side of the electrode assembly 10. The cover portion 51 may have a rectangular plate shape, but the shape of the cover portion 51 is not particularly limited as long as it partially covers the electrode assembly 10.

An outward-facing surface 51a of the cover portion 51 may be provided to be exposed outward from the connector 40. Here, the outward-facing surface 51a may be a surface among the outer surfaces of the cover portion 51 that faces outward of the electrode assembly 10. At this time, the outward-facing surface 51a may be disposed on the same plane as one surface of the connector 40. For example, the outward-facing surface 51a may be disposed on the same plane as one surface of a coupling portion 41 of the connector 40 described later. Also, the outward-facing surface 51a may be positioned further outward than the one surface of the coupling portion 41.

With such a configuration, spatial utilization may be improved when multiple secondary batteries 3 are arranged. Here, the outward-facing surface 51a may refer to a surface facing forward (e.g., positive direction of the X axis) from the cover portion 51 based on FIG. 6, and the one surface of the coupling portion 41 may refer to an end surface facing forward (e.g., positive direction of the X axis).

The extension portion 54 of the cover 50 may extend toward the electrode assembly 10. That is, the extension portion 54 may extend from the cover portion 51 toward the electrode assembly 10. Specifically, the extension portion 54 may be provided with an end surface 54c facing the electrode assembly 10 to be exposed to the inside of the connector 40. At this time, the extension portion 54 may extend from an edge of the cover portion 51.

Referring to FIGS. 5 and 6, the extension portion 54 of the cover 50 may be formed in plural. Here, at least one of the extension portions 54 may be provided such that the end surface 54c facing the electrode assembly 10 is exposed to the inside of the connector 40. For example, among a plurality of extension portions 54 extending from the cover portion 51 toward the electrode assembly 10, some may be embedded in the connector 40, while others may be exposed to the inside of the connector 40.

In the first embodiment of the present disclosure, however, descriptions will be made on a case where all of the plurality of extension portions 54 are exposed to the inside of the connector 40. For example, the plurality of extension portions 54 may include first to fourth extension portions 55 to 58.

Referring to FIGS. 5 and 6, the first and second extension portions 55 and 56 may extend side by side from both sides of the cover portion 51 in a width direction (e.g., Y-axis direction). The first extension portion 55 and the second extension portion 56 may be disposed spaced apart by a predetermined distance in the width direction. At this time, the width direction (e.g., Y-axis direction) may be a direction perpendicular to a stacking direction (e.g., Z-axis direction) of the electrodes and the separator. The first and second extension portions 55 and 56 may have a partition (or plate) shape having a predetermined thickness.

The third and fourth extension portions 57 and 58 may extend side by side from both sides of the cover portion 51 in a height direction (e.g., Z-axis direction). The third extension portion 57 and the fourth extension portion 58 may be disposed spaced apart by a predetermined distance in the height direction. At this time, the height direction (e.g., Z-axis direction) may be a direction parallel to the stacking direction (e.g., Z-axis direction) of the electrodes and separator. The third and fourth extension portions 57 and 58 may have a partition (or plate) shape having a predetermined thickness.

At this time, the first to fourth extension portions 55 to 58 may be connected to each other. As a result, when viewed in the longitudinal direction (e.g., X-axis direction) of the electrode assembly 10, the first to fourth extension portions 55 to 58 may have an overall ring shape. In other words, the first to fourth extension portions 55 to 58 may have a ring shape following a circumferential direction of the electrode assembly 10. In this case, the ring shape may be a shape viewed in a longitudinal direction (e.g., X-axis direction) of the electrode assembly 10.

Referring to FIG. 5, the end surface 54c of the extension portion 54 that is exposed to the inside of the connector 40 may be disposed spaced apart from the electrode assembly 10. Accordingly, damage to the electrode assembly 10 by the extension portion 54 may be prevented.

Meanwhile, in the present embodiment, the extension portion 54 has been described as being formed of the first to fourth extension portions 55 to 58. However, if necessary, the extension portion 54 may be configured to include only some of the first to fourth extension portions 55 to 58. For example, the extension portion 54 may be configured of the first and second extension portions 55 and 56, and may be open in a height direction (e.g., Z-axis direction).

Referring to FIGS. 2 to 6, the extension portion 54 may be embedded in the connector 40 by being fitted into a groove formed in the connector 40. The connector 40 and the cover 50 may be coupled while a portion of the cover portion 51 and a portion of the extension portion 54 are fitted into the connector 40 (see, e.g., FIGS. 2 to 6). At this time, the connector 40 and the extension portion 54 may be bonded to each other by heat sealing. In addition, the connector 40 and the extension portion 54 may be bonded to each other through an adhesive applied therebetween. Here, a type and an application form of the adhesive for bonding the connector 40 and the extension portion 54 may be various. For example, the adhesive may be made up of a material having relatively high hydrophobicity.

In a case where the connector 40 and the extension portion 54 are bonded by heat sealing, the connector 40 may include a resin material having adhesiveness by heat. That is, the resin material of the connector 40 having adhesiveness by heat may melt, and the connector 40 may be bonded to the extension portion 54 by pressure. Through this process, the connector 40 and the cover 50 may be coupled.

In the meantime, although not described in detail in the present disclosure, the cap 30 may further include an electrolyte injection port for injecting an electrolyte or a gas discharge port for discharging gas in a degassing process.

The cap 30 of the secondary battery 3 according to the first embodiment of the present disclosure may cover the electrode assembly 10 with the connector 40 and the cover 50 embedded at least partially in the connector 40. Depending on a material of the connector 40, for example, moisture outside the connector 40 may penetrate to the inside of the connector 40 through the connector 40. Penetration of moisture may cause defects of the secondary battery 3.

The cap 30 of the secondary battery 3 according to the first embodiment of the present disclosure may cover the electrode assembly 10 with the cover 50 including a material having excellent waterproof properties, such as metal, together with the connector 40. Accordingly, an area of the connector 40 through which moisture may penetrate, may be reduced. In addition, since at least a portion of the cover 50 is embedded in the connector 40, it may be difficult for moisture to penetrate between the cover 50 and the connector 40. Therefore, the secondary battery 3 according to the first embodiment of the present disclosure may reduce an amount of moisture penetrating into an interior, thereby reducing occurrence of problems in performance of the secondary battery 3.

In addition, the cap 30 of the secondary battery 3 according to the first embodiment of the present disclosure may be arranged such that the extension portion 54 of the cover 50 is embedded in the connector 40. Accordingly, the connector 40 may restrict movement of the cover 50 and prevent separation of the cover 50, thereby improving structural stability of the secondary battery 3.

Further, since the cap 30 of the secondary battery 3 includes the terminal 60, the secondary battery 3 may be electrically connected to the outside efficiently. In addition, the terminal 60 may be connected to various forms of electrode assemblies 10 by modifying a shape and arrangement thereof, and may be connected efficiently to electrode tabs 11 even when the number of the electrode tabs 11 increases.

Although not described in detail in the present embodiment, the cap 30 may further include a gas discharge member (not illustrated) for discharging gas inside the secondary battery 3, or a venting member (not illustrated) for guiding venting in a specific direction.

### Embodiment 2

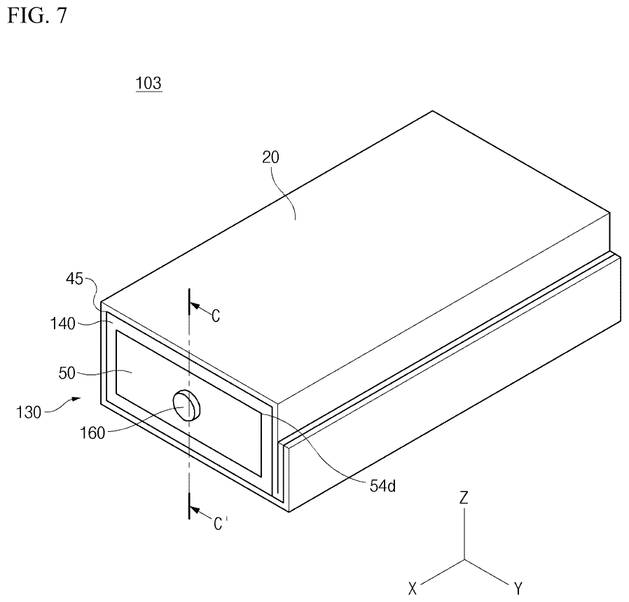

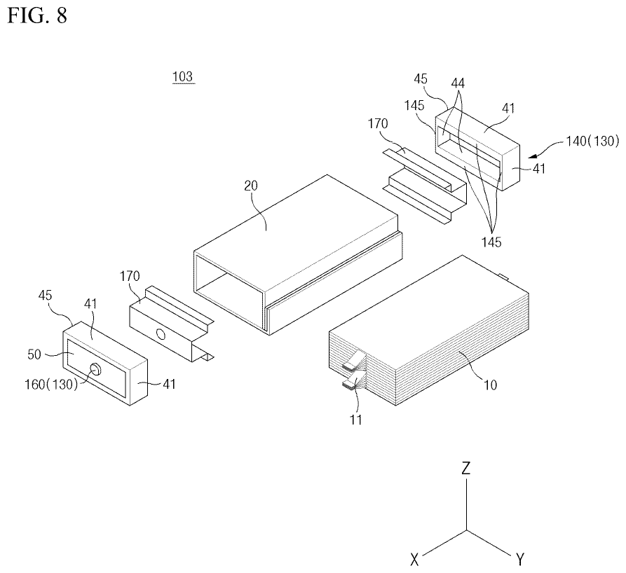

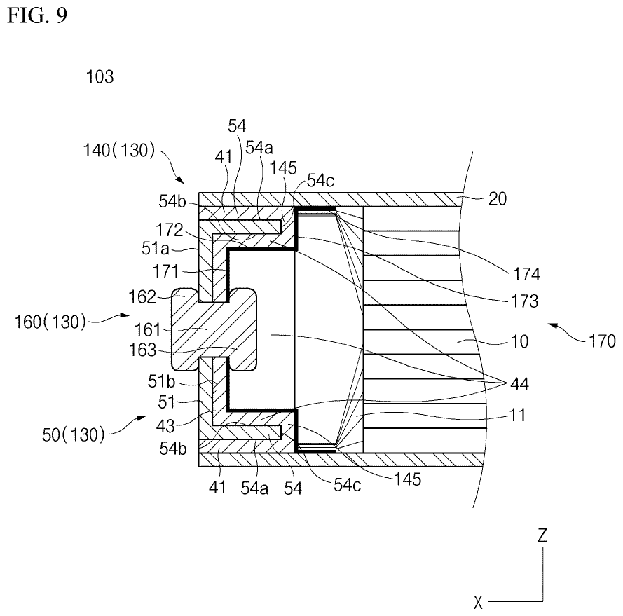

FIG. 7 is a perspective view of a secondary battery according to a second embodiment of the present disclosure as viewed from above. FIG. 8 is an exploded perspective view of the secondary battery illustrated in FIG. 7. FIG. 9 is a partial sectional view taken along line C-C′ of FIG. 7.

Hereinafter, a detailed description of the same configurations as those of the secondary battery 3 according to the first embodiment of the present disclosure (illustrated in FIG. 2) will be omitted, and differences between the first embodiment and the second embodiment will be mainly described.

Referring to FIGS. 7 to 9, a secondary battery 103 according to the second embodiment of the present disclosure may differ from the secondary battery 3 according to the first embodiment (illustrated in FIG. 2) in a shape of a connector 140, a shape of a terminal 160, presence or absence of a busbar 170, and a coupling manner of components. The secondary battery 103 according to the second embodiment of the present disclosure may include an electrode assembly 10, an exterior film 20, and a cap 130.

In the present embodiment, the exterior film 20 of the secondary battery 103 may have a rolled shape in which a sheet or film is wound along side surfaces of the electrode assembly 10. For example, the exterior film 20 may be disposed in a manner surrounding side portions of the electrode assembly 10. In this case, one end and the other end of the exterior film 20 may meet each other to surround the electrode assembly 10. In relation to a manner in which one end and the other end of the exterior film 20 meet each other, one surface of the one end and one surface of the other end may be coupled with each other while overlapping (see, e.g., FIG. 7). However, this is merely an example, and various forms of coupling between the one end and the other end of the exterior film 20 may be used to form a space accommodating the electrode assembly 10.

Referring to FIGS. 7 to 9, the cap 130 of the secondary battery 103 may include a connector 140, a cover 50, and a terminal 160. The connector 140 of the cap 130 may be coupled with the exterior film 20, and the cover 50 of the cap 130 may be coupled with the connector 140 such that a portion thereof is exposed to the outside of the connector 140. The terminal 160 of the cap 130 may penetrate the connector 140 and the cover 50. In addition, one end and the other end of the terminal 160 may be exposed respectively to an outer side and an inner side of the connector 140.

Description will now be provided in more detail regarding configurations of the cap 130.

In the present embodiment, the cover 50 may be configured in the same manner as the cover of the secondary battery according to the first embodiment. The cover 50 may include a cover portion 51 and an extension portion 54. One surface of the cover portion 51 may be arranged to be exposed to the outside of the connector 140. Hereinafter, the one surface is referred to as an outward-facing surface 51a, and a surface opposite to the outward-facing surface 51a is referred to as an inward-facing surface 51b. The inward-facing surface 51b may be a surface facing the electrode assembly 10.

In the present embodiment, the extension portion 54 may be embedded in the connector 140. For example, one end of the extension portion 54 may not be exposed to the inside of the connector 140. To achieve this, the connector 140 may include an end-side portion 145 provided at an end side of the extension portion 54 and connecting an extension portion-side portion 44 and a coupling portion 41. The end-side portion 145 may be a portion that covers an end surface 54c of the extension portion 54.

Such a structure may secure not only structural stability of the cap 30 but also stability of the coupling portion 41, which is sealed between the cap 30 and the exterior film 20. For example, an advantage may be expected in that venting direction may be controlled. When the extension portion 54 is embedded entirely in the connector 140 and when there is no portion exposed toward an inner side, the possibility that the coupling portion 41 may be peeled from the extension portion 54 of the cover 50 may be eliminated.

For example, in a situation where internal pressure of the secondary battery 3 rapidly increases and internal gas explosively discharges, or in a situation where flame is discharged to the outside due to fire, no crack through which gas or flame may discharge exists toward the cap 30. Accordingly, venting toward the cap 30 may be prevented. Therefore, heat transfer that may occur due to venting toward the cap 30 in a state in which batteries are assembled into a battery pack may be suppressed.

In the present embodiment, the end-side portion 145 may have a ring shape corresponding to the shape of the extension portion 54. In this case, the ring shape may be a shape viewed in an extension direction (e.g., X-axis direction) of the electrode assembly 10.

In the present embodiment, the end-side portion 145 may be connected to the coupling portion 41 and the extension portion-side portion 44, respectively. As a result, the extension portion 54 may be completely embedded in the connector 140. Accordingly, penetration of moisture into a space in which the electrode assembly 10 is accommodated may be further suppressed. The reason is that a gap at a joint between the outer surface 54a of the extension portion 54 and the coupling portion 41, through which moisture may penetrate, may be blocked by the end-side portion 145.

In addition, through the configuration described above, discharge of gas or flame under abnormal conditions, such as a pressure increase or an explosion inside the secondary battery, may be guided toward the exterior film 20. The reason is that the gap between the outer surface 54a of the extension portion 54 and the coupling portion 41 may be blocked by the end-side portion 145, so discharge of gas or flame through the cap 130 may be suppressed.

As such, in the second embodiment of the present disclosure, since the extension portion 54 is entirely embedded in the connector 140, structural stability of the cap 30 may be improved, and a direction of discharge of gas or flame may be effectively controlled. Furthermore, no protruding shape is present on the other surface of the connector 140 facing the electrode assembly 10. A portion of the busbar 170, which will be described later, may be disposed in this region.

Regarding the structure of the terminal portion 160 of the cap 130, the terminal portion 160 may include a body portion 161, an outer portion 162, and an inner portion 163. For example, the outer portion 162 may be connected to one end of the body portion 161, and the inner portion 163 may be connected to the other end.

The body portion 161 of the terminal portion 160 may be disposed to penetrate the connector 140 and the cover 50. For example, an outer circumferential surface of the body portion 161 may contact the connector 140 and the cover 50. A gasket may be provided along an outer circumference of the body portion 161 to prevent leakage of electrolyte.

The outer portion 162 of the terminal portion 160 may be exposed to the outer side of the connector 140. Therefore, when the secondary battery 103 is electrically connected to the outside to provide electric energy, the outer portion 162 may be connected to the outside. The inner portion 163 may be exposed to the inner side of the connector 140. Therefore, the inner portion 163 may be electrically connected to the electrode assembly 10.

In the second embodiment of the present disclosure, the outer portion 162 and the inner portion 163 of the terminal 160 may have a cross-sectional area larger than that of the body portion 161. Referring to FIG. 9, the terminal 160 may be fitted into the connector 140 and the cover 50 by the outer portion 162 and the inner portion 163. Accordingly, separation of the terminal 160 may be prevented, thereby improving structural stability of the cap 130.

The body portion 161, outer portion 162, and inner portion 163 of the terminal 160 according to the second embodiment may each have a generally cylindrical shape. For example, the body portion 161, outer portion 162, and inner portion 163 may have a generally circular cross-section. This is merely one example, and the body portion 161, outer portion 162, and inner portion 163 may alternatively have a different cross-sectional shape.

As described above, the inner portion 163 of the terminal 160 extending to the inside of the connector 140 may be electrically connected to the electrode assembly 10. Here, the electrical connection may include both direct connection between the inner portion 163 and the electrode assembly 10 and indirect connection via another electrically conductive component.

When the inner portion 163 is directly connected to the electrode assembly 10, the electrode tab 11 of the electrode assembly 10 may be connected to the inner portion 163. In addition, when the inner portion 163 is indirectly connected to the electrode assembly 10, the secondary battery 103 may include a busbar 170 as an example of another electrically conductive member serving as a medium.

The busbar 170 may be disposed between the connector 140 and the electrode assembly 10 to electrically connect the inner portion 163 exposed to the inside of the connector 140 and the electrode assembly 10. The busbar 170 may be formed of a metal material to provide electrical conductivity. In addition, the busbar 170 may be arranged in various shapes according to the length or extension state of the inner portion 163.

As an example of a configuration for efficient arrangement, the busbar 170 according to the second embodiment of the present disclosure may include a first metal portion 171, a second metal portion 172, a third metal portion 173, and a fourth metal portion 174.

Referring to FIG. 9, the first metal portion 171 may contact the connector 140 and the inner portion 163. One surface of the first metal portion 171 facing the connector 140 may be arranged to contact the connector 140. In addition, the other surface of the first metal portion 171 facing the inner portion 163 may be arranged to contact the inner portion 163. In this regard, the first metal portion 171 may have a plate-like shape and may include a hole formed in its center. The body portion 161 of the terminal 160 may penetrate the hole, and the other surface of the first metal portion 171 facing the inner portion 163 may contact the inner portion 163. For example, the first metal portion 171 of the busbar 170 may be arranged so as to be caught by the inner portion 163 such that movement of the first metal portion 171 toward the electrode assembly 10 is restricted by the inner portion 163. Therefore, the busbar 170 may be effectively fixed. In the meantime, the terminal 160 may include a metal material, and the inner portion 163 of the terminal 160 and the first metal portion 171 may be joined to each other by welding.

The second metal portion 172 may extend from the first metal portion 171 toward the electrode assembly 10. The second metal portion 172 may extend in a direction substantially perpendicular to the longitudinal direction of the first metal portion 171. In addition, one surface of the second metal portion 172 facing the connector 140 may be arranged to contact the connector 140.

The third metal portion 173 may extend from the second metal portion 172 toward the exterior film 20. The third metal portion 173 may extend in a direction substantially perpendicular to the longitudinal direction of the second metal portion 172. For example, the third metal portion 173 may extend in a direction away from the inner portion 163. In addition, one surface of the third metal portion 173 facing the connector 140 may be arranged to contact the connector 140.

The fourth metal portion 174 may extend from the third metal portion 173 toward the electrode assembly 10. In addition, one surface of the fourth metal portion 174 facing the exterior film 20 may be arranged to contact the exterior film 20.

In the meantime, one end of the fourth metal portion 174 may be connected to the electrode assembly 10. For example, one end of the fourth metal portion 174 may be connected to the electrode tab 11 of the electrode assembly 10. In this regard, the second metal portion 172, the third metal portion 173, and the fourth metal portion 174 may be formed as a pair. Here, a plurality of electrode tabs 11 of the electrode assembly 10 may be respectively connected to the closest fourth metal portion 174. Therefore, even when the secondary battery 103 includes a plurality of electrode assemblies 10 and the number of electrode tabs 11 increases, the fourth metal portion 174 may be efficiently connected to the electrode tabs 11.

The busbar 170 according to the second embodiment of the present disclosure may be arranged in a state of being in contact with the exterior film 20 or the cap 130. Accordingly, structural stability of the secondary battery 103 may be improved. In addition, since the busbar 170 includes the first metal portion 171, the second metal portion 172, the third metal portion 173, and the fourth metal portion 174, the busbar 170 may be applied in various forms according to the number, arrangement, and shape of the electrode assembly 10.

The configuration of the busbar 170 described in the present disclosure is merely an example. Therefore, the shape and arrangement of the busbar 170 may vary.

### Embodiment 3

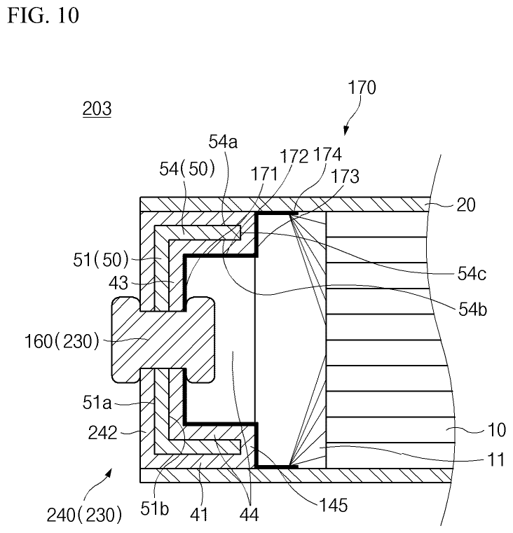

FIG. 10 is a partial sectional view taken along line C-C′ of FIG. 7 of a secondary battery according to a third embodiment of the present disclosure.

In the secondary battery 203 according to the third embodiment of the present disclosure, the electrode assembly, exterior film, cover of the cap, terminal, and busbar may each be configured identically or similarly to those of the secondary battery 103 according to the second embodiment (illustrated in FIGS. 7 to 9).

Referring to FIG. 10, in the secondary battery 203 according to the third embodiment of the present disclosure, the connector 240 of the cap 230 may further include an outer portion 242. The outer portion 242 may be a component for covering the outer-facing surface 51a of the cover portion 51 among the outer surfaces of the cover portion 51, which is oriented toward the outside of the electrode assembly 10. As a result, the cover portion 51 may be covered by the outer portion 242 at the outer-facing surface 51a and by the inner portion 43 at the inner-facing surface 51b. That is, the cover portion 51 may be entirely embedded in the connector 240.

In the present embodiment, the outer portion 242 may have a plate shape covering the entire outer-facing surface 51a. Through this configuration, the cover 50 may be protected from external impact and contamination. However, the shape of the outer portion 242 is not particularly limited, as long as the outer-facing surface 51a is covered.

In the meantime, in the present embodiment, an edge portion of the outer portion 242 may be connected to the coupling portion 41. The outer portion 242 may be integrally provided with the coupling portion 41. The outer portion 242 may be formed of the same material as the coupling portion 41.

Accordingly, the cover 50 may be entirely surrounded by the connector 240, thereby improving coupling strength between the connector 240 and the cover 50. In addition, since the gap between the coupling portion 41 and the outer surface 54a of the extension portion 54 is blocked by the outer portion 242, penetration of moisture into the space in which the electrode assembly 10 is accommodated, may be very effectively suppressed.

In the meantime, in the present embodiment, the body portion 161 of the terminal 160 may extend through the cover 50 and the inner portion 43 to penetrate the outer portion 242. The outer portion 162 of the terminal 160 may be provided at an end of the body portion 161. Here, the end of the body portion 161 may be a portion directed toward the outer portion 242.

In this case, the outer portion 162 may have a cross-sectional area larger than that of the body portion 161. Accordingly, one side of the outer portion 162 may be caught by the outer portion 242, thereby restricting movement (or disengagement) of the terminal 160.

As such, according to the present embodiment, since the outer-facing surface 51a of the cover 50 is covered by the outer portion 242, durability and coupling strength may be improved, and insulation between the terminal 160 and other components may also be enhanced. In addition, heat transfer may be suppressed by the outer portion 242 in a thermal runaway situation.

Furthermore, in the present embodiment, since the cover 50 made of a metal material is surrounded by the connector 240, the cap 230 may be easily manufactured by an insert injection molding process. As a result, the productivity of the secondary battery may be improved, the manufacturing process may be simplified, and the manufacturing cost may be reduced.

### Embodiment 4

FIG. 11 is a partial sectional view taken along line C-C′ of FIG. 7 of a secondary battery according to a fourth embodiment of the present disclosure. Referring to FIG. 11, an electrode assembly 10, an exterior film 20, a cover 50, a terminal portion 160, and a busbar 170 of the secondary battery 303 according to the fourth embodiment may be configured identically or similarly to those of the secondary battery according to the second embodiment.

In this case, a connector 340 in a cap 330 of the secondary battery 303 according to the fourth embodiment may include the coupling portion 41. The outer-facing surface 51a and inner-facing surface 51b of the cover portion 51, and the inner surface 54b and end surface 54c of the extension portion 54 may not be covered by the connector 340.

In other words, the outer-facing surface 51a, the inner-facing surface 51b, the inner surface 54b, and the end surface 54c may be exposed. Also, if necessary, at least a portion of the inner-facing surface 51b, the inner surface 54b, and/or the end surface 54c may be covered by the busbar 170.

In the present embodiment, the connector 340 may have a ring shape surrounding the outer surface 54a (or outer circumferential surface) of the extension portion 54. As such, the connector 340 may be configured simply and compactly using only the coupling portion 41. Accordingly, the secondary battery 303 may achieve reinforcement in rigidity by the cover 50 while also being lightweight.

### Connector

Modifications of the connectors 40, 140, 240, and 340 according to Embodiments 1 to 4 of the present disclosure, for example, modifications of the coupling portion 41 and the corner edge 45 of the connector 40, will be described in more detail. The following description of modifications may be applied to Embodiments 1 to 4 of the present disclosure, and may include modifications possible for those skilled in the art.

### Modifications of Coupling Portion

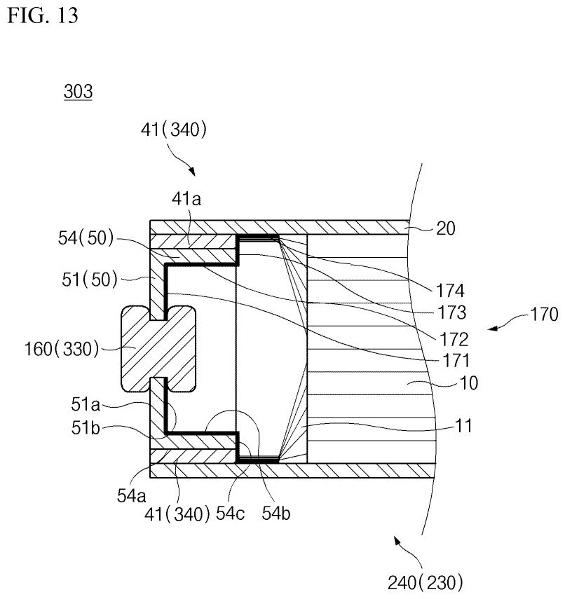

First, referring to FIG. 13, in the first modification, the coupling portion 41 of the connector 340 according to the fourth embodiment of the present disclosure may include a first layer 41a that contains a first resin, and has an outer surface allowing coupling to an inner surface of the exterior film 20, and an inner surface allowing coupling to an outer surface of the cover 50.

The first resin included in the first layer 41a may be a material that facilitates coupling between the cover 50 and the exterior film 20. For example, the first resin may have a melt flow rate (MFR) of about 4 g/10 min to 14 g/10 min at 230° C.

The connector 40 or 340 between the cover 50 and the exterior film 20 may play an important role in maintaining airtightness during sealing. As previously described, controlling the radius of curvature of the corner edge is essential to prevent unsealed regions. However, sealing performance may also depend on the type of material applied to the first layer 41a of the coupling portion 41. The first layer 41a may include the first resin, and the first resin may have a melt flow rate of 4 g/10 min to 14 g/10 min, for example, 5 g/10 min or more, or 6 g/10 min or more, and 13 g/10 min or less, or 12 g/10 min or less.

The melt flow rate is an index indicating the flowability of a resin in a molten state. During sealing, the resin melts and thermally welds onto the contact surface, and the sealing strength and presence of unsealed regions may vary depending on the melt flow rate of the resin. Sealing of the secondary battery case is performed by applying high heat for a very short time, during which melting and solidification occur instantaneously. Accordingly, melt flow characteristics may significantly influence sealing effectiveness, making it necessary to apply a first resin having the melt flow rate described above to the first layer 41a.

In addition, the first resin may include a resin having a melting point (Tₘ) of about 135° C. to 150° C. and a melt flow rate (MFR) at 230° C. of about 4 g/10 min to 14 g/10 min. When the first resin having such physical properties is applied to the first layer 41a, excellent heat resistance may allow thermal fusion at high temperature without external deformation, thereby securing high sealing strength and durability capable of responding to internal pressure increases caused by gases generated inside the secondary battery.

For example, the first resin may include a modified polyolefin resin. The first resin may be contained in the first layer in an amount exceeding 50 parts by weight, and for example may be contained in an amount of 70 parts by weight or more, 80 parts by weight or more, or 90 parts by weight or more. The first resin may be applied alone, or when blended, the remaining part may include another suitable resin such as another polyolefin-based resin.

The modified polyolefin resin may be modified by acid or siloxane, and for example, may be modified by acid, or may be a polyolefin copolymerized with a monomer containing acrylic acid or post-treated with acid. For example, the modified polyolefin resin may be acid-modified polypropylene or acid-modified polyethylene, and plasma-treated polypropylene or polyethylene may also be applied. Functional groups introduced through the modification may enhance adhesion to a metal surface, thereby improving adhesion between the metal and the resin. Accordingly, considering that metal may be employed as the material of the cover 50, the resin described above may be applied to the connector 40.

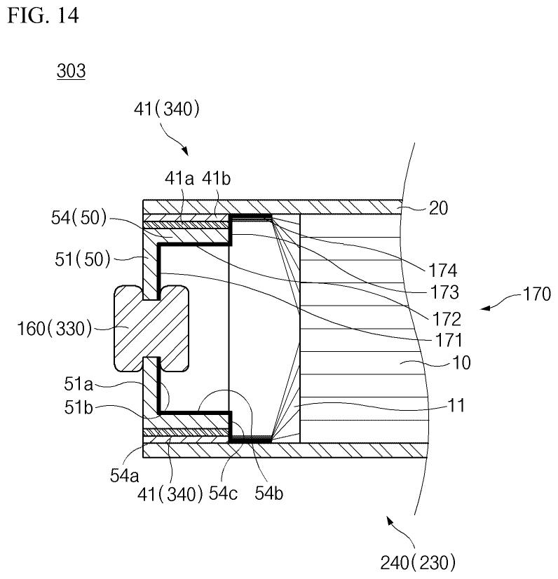

Referring to FIG. 14, in a second modification, the coupling portion 41 of the connector 340 may include the first layer 41a containing the first resin that allows coupling to the outer surface of the cover 50, and a second layer 41b containing a second resin, laminated on the outer surface of the first layer and allowing coupling to the inner surface of the exterior film 20.

For example, the first resin contained in the first layer 41a may be as previously described, and the second resin contained in the second layer 41b may include a resin having a melting point (Tₘ) of about 120° C. to 145° C., a melt flow rate (MFR) at 230° C. of about 5 g/10 min to 18 g/10 min, or a resin selected from those having both a melting point (Tₘ) of about 120° C. to 145° C. and an MFR of about 5 g/10 min to 18 g/10 min.

In another example, the first resin and the second resin may satisfy at least one of Formulas 1 and 2 below:

$${T}_{m 2} > {T}_{m 1} \qquad [ Formula 1 ]$$

In Formula 1, Tₘ₁ is a melting point of the first resin, and Tₘ₂ is a melting point of the second resin, in ° C.

$$MFR 2 > MFR 1 \qquad [ Formula 2 ]$$

In Formula 2, MFR1 is a melt flow rate of the first resin, and MFR2 is a melt flow rate of the second resin, in g/10 min.

When the connector 340 is configured as a double layer, the bonding strength with the cover 50 and the bonding strength with the exterior film 20 may be increased compared with when it is configured as a single layer, thereby enabling a higher sealing strength. For example, when a resin having a higher melting point or a higher melt flow rate than the first resin applied to the first layer 41a is included as the second resin in the second layer 41b, the material properties may become more similar to those of the exterior film 20. Accordingly, not only may sealing processability be improved, but also bonding strength by heat welding may be enhanced, resulting in a substantial improvement in sealing strength and durability against internal pressure increase.

For example, the first resin included in the first layer 41a is as described above, and the second resin included in the second layer 41b may be a polyolefin-based resin. The distinction between the first resin and the second resin may lie in whether a modifying group is introduced. The second resin may be an unmodified polyolefin-based resin, and may include polypropylene or polyethylene, which may be a homopolymer, or a block copolymer or random copolymer containing a small amount of comonomer. In addition, when the second resin is included in the second layer, its content may be the same as the content of the first resin included in the first layer.

The polyolefin-based resin may be, for example, an unoriented polyolefin-based resin. The unoriented polyolefin-based resin is not stretched in a specific direction during manufacturing or processing and is produced by casting. Therefore, the resin may be more flexible and less prone to directional tearing compared with a stretched polyolefin-based resin, and may be relatively easy to process. However, since the connector 40 may be manufactured together with the cover 50 by insert injection and a certain level of rigidity may be required depending on the characteristics of the cap 30, an appropriate selection may be made between the unoriented polyolefin-based resin and the stretched polyolefin-based resin depending on the required properties.

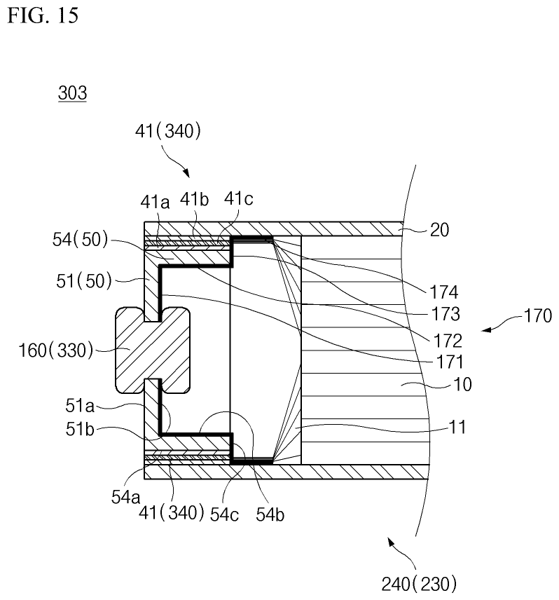

Referring to FIG. 15, the coupling portion 41 of the connector 340, as a third modification, may include a first layer 41a including the first resin and permitting bonding with the outer surface of the cover 50, a second layer 41b including the second resin and permitting bonding with the inner surface of the exterior film 20, and a third layer 41c including a third resin and disposed between the first layer 41a and the second layer 41b.

For example, the first resin and the second resin are as described above, and the third resin may include one selected from a resin having a melting point (Tₘ) of about 145° C. to about 170° C., a resin having a melt flow rate (MFR) of about 2 g/10 min to about 4 g/10 min at 230° C., and a resin having both a melting point (Tₘ) of about 145° C. to about 170° C. and a melt flow rate (MFR) of about 2 g/10 min to about 4 g/10 min at 230° C.

In still another example, the first resin, the second resin, and the third resin may satisfy at least one of Formulas 3 and 3 below:

$${T}_{m 3} > {T}_{m 2} > {T}_{m 1} \qquad [ Formula 3 ]$$

In Formula 3, Tₘ₁ is a melting point of the first resin, Tm₂ is a melting point of the second resin, and Tₘ₃ is a melting point of the third resin, in ° C.

$$MFR 2 > MFR 1 > MFR 3 \qquad [ Formula 4 ]$$

In Formula 4, MFR1 is a melt flow rate of the first resin, MFR2 is a melt flow rate of the second resin, and MFR3 is a melt flow rate of the third resin, in g/10 min.

In the case where the connector 340 is configured as a triple-layer structure, the third layer 41c, which is provided between the first layer 41a and the second layer 41b, may be selected to have a higher melting point and a lower melt flow rate than the other layers. In this case, deformation of the connector due to heat may be minimized, thereby ensuring not only sealing strength but also insulation.

The third resin applicable to the third layer 41c may, for example, be selected from resins within the same category as the second resin that satisfy the above-described melting point and melt flow rate ranges. For example, the third resin may be a homo-polyolefin resin that is a single polymer.

According to Embodiments 1 through 4 of the present disclosure, the connector (40, 140, 240, 340) may be provided on one surface of the cover 50 and may include connecting portions (242, 43, 44, 145) provided on at least one surface (e.g., the inner surface 54b, the end surface 54c, the outer-facing surface 51a, the inner-facing surface 51b) of the cover 50 other than the surface (e.g., the outer surface 54a) on which the coupling portion 41 is provided.

The connecting portion (242, 43, 44, 145) of the connector (40, 140, 240, 340) may include a first layer including the first resin, the first layer having an inner surface that allows coupling to one surface of the cover 50, as in the first modification of the coupling portion 41.

The connecting portion (242, 43, 44, 145) of the connector (40, 140, 240, 340) may include a first layer including the first resin, the first layer having an inner surface that allows coupling to one surface of the cover 50, and a second layer including the second resin, the second layer being laminated on an outer surface of the first layer.

The connecting portions (242, 43, 44, 145) of the connector (40, 140, 240, 340) may include a first layer including the first resin, the first layer having an inner surface that allows coupling to one surface of the cover 50, a second layer including the second resin and disposed at the outermost side, and a third layer including the third resin disposed between the first layer and the second layer.

More specifically, the connector 40 may further include connecting portions that cover one surface of the cover 50 in addition to the coupling portion 41. As illustrated in Embodiment 1 of FIG. 5, the connecting portions may include an inner portion 43 provided on the inner-facing surface 51b of the cover 50, and an extension portion-side portion 44 provided on the inner surface 54b (or inner circumferential surface) of the extension portion 54. The inner portion 43 and the extension portion-side portion 44 may independently adopt the same or different modifications as the first through third modifications of the coupling portion 41. In general, since the cap 30 is manufactured by insert injection molding, the same modifications may be applied.

In another example, the connector 40 may further include connecting portions that cover one surface of the cover 50 in addition to the coupling portion 41. As illustrated in Embodiment 2 of FIG. 9, the connecting portions may include the inner portion 43 provided on the inner-facing surface 51b of the cover 50, the extension portion-side portion 44 provided on the inner surface 54b (or inner circumferential surface) of the extension portion 54, and the end-side portion 145 that covers the end surface 54c of the extension portion 54. The inner portion 43, the extension portion-side portion 44, and the end-side portion 145 may independently adopt the same or different modifications as the first through third modifications of the coupling portion 41. In general, since the cap 30 is manufactured by insert injection molding, the same modifications may be applied.

In still another example, the connector 40 may further include connecting portions that cover one surface of the cover 50 in addition to the coupling portion 41. As illustrated in Embodiment 3 of FIG. 10, the connecting portions may include the inner portion 43 provided on the inner-facing surface 51b of the cover 50, the extension portion-side portion 44 provided on the inner surface 54b (or inner circumferential surface) of the extension portion 54, the end-side portion 145 that covers the end surface 54c of the extension portion 54, and the outer portion 242 that covers the outer-facing surface 51a of the cover 50. The inner portion 43, the extension portion-side portion 44, the end-side portion 145, and the outer portion 242 may independently adopt the same or different modifications as the first through third modifications of the coupling portion 41. In general, since the cap 30 is manufactured by insert injection molding, the same modifications may be applied.

### Manufacturing Method

Hereinafter, referring to FIGS. 2 to 4, descriptions is made on a manufacturing method of the secondary battery according to Embodiments 1 through 4 of the present disclosure.

The manufacturing method may include: (S1) a step of assembling the electrode assembly 10 and the exterior film 20 that surrounds a portion of the electrode assembly 10; and (S2) a step of arranging the cap 30 so as to contact the exterior film 20 and sealing the cap 30 that surrounds the remaining portion of the electrode assembly 10.

As described above, the cap 30 may include the cover 50 that covers one side of the electrode assembly 10 in the extending direction, the connector 40 provided on the outer surface of the cover 50 and including a plurality of coupling portions 41 that are coupled with the exterior film 20, and the terminal 60 that is at least partially exposed to the outside of the cover 50 and electrically connected to the electrode assembly 10. The cap 30 may be arranged such that the coupling portion 41 of the connector 40 contacts the exterior film 20.

In the manufacturing method, sealing between films of the exterior film 20, manufacturing of the cap including the cover 50, the connector 40, and the terminal 60, and accommodation of the electrode assembly 10 may be performed in the same manner as previously described with respect to each corresponding component. Since their functions and operations are substantially the same, detailed description thereof is omitted.

After the step S2, a step of injecting an electrolyte may be further included. This has already been described in detail in relation to the structure of the cover 50, and therefore, detailed description thereof is omitted.

In the step S2, sealing may be affected by the sealing pressure and temperature, the melting point and melt flow rate of the resin applied to the coupling portion 41 of the connector 40, and the radius of curvature of the corner edge 45. Since the characteristics of the applied resin and the radius of curvature of the corner edge 45 have already been described, detailed description thereof is omitted.

In the step S2, sealing may be performed at about 200° C. to 270° C. For example, sealing may be performed at temperatures of about 210° C. or higher, 220° C. or higher, or 230° C. or higher, and also at about 260° C. or lower or about 250° C. or lower. When sealing is performed within the above temperature range, appropriate heat may be supplied in accordance with the melt flow rate of the first resin, the second resin, and/or the third resin of the connector described above, thereby enabling sufficient sealing strength.

In the step S2, pressure may be about 0.05 MPa to 1.20 MPa based on surface pressure. For example, pressure may be about 0.06 MPa or greater, 0.10 MPa or greater, 0.13 MPa or greater, or 0.15 MPa or greater, and also about 1.00 MPa or lower, 0.90 MPa or lower, or 0.80 MPa or lower. The surface pressure may be defined as a ratio of the sum of the pressing force and gravity applied by a sealing block to the sealing area. When the surface pressure is controlled within the above range, sufficient sealing strength may be secured and improved internal pressure resistance may be achieved.

The secondary battery may be sealed between the exterior film 20 and the coupling portion 41 by sealing methods such as those illustrated in FIGS. 11 and 12. The sealing temperature and pressure (surface pressure) described above may be considered when sealing using such sealing blocks. As described above, whereas the conventional method applying heat and pressure from both directions primarily considers only the maximum thermal tolerance of the resin, the present method applying heat and pressure from one direction allows consideration not only of the maximum thermal tolerance of the sealing materials but also the minimum heat or pressure required to secure an appropriate sealing strength.

### EXAMPLES AND COMPARATIVE EXAMPLES

Hereinafter, examples and comparative examples relating to the coupling portion 41 and the corner edge 45 of the connector 340 are described so that those having ordinary skill in the art to which the present disclosure pertains can readily carry out the present disclosure. However, the present disclosure may be implemented in many different forms and is not limited to the embodiments described herein.

### Example 1

An exterior film having a polyethylene terephthalate/nylon/aluminum-alloy thin film/polypropylene structure was prepared by laminating a polyethylene terephthalate (PET) film having a width of 266 mm, a length of 50 m, and a thickness of 12 m and a nylon film having a width of 266 mm, a length of 50 m, and a thickness of 25 m on one surface of an aluminum-alloy thin film having a width of 266 mm, a length of 50 m, and a thickness of 60 μm, and laminating a polypropylene film having a width of 266 mm, a length of 50 m, and a thickness of 80 μm on the other surface of the aluminum-alloy thin film. Here, the polyethylene terephthalate film and the nylon film are substrate layers, the aluminum-alloy thin film is a gas barrier layer, and the polypropylene film is a sealant layer.

Next, the coupling portion 41 of the cover 50 and the connector 40 having the shape illustrated, for example, in FIG. 5 was prepared by insert-molding using an aluminum metal plate and a polypropylene resin, each having the radii of curvature and melt flow rate (MFR) shown in Table 1 below.

An electrode assembly was prepared by simulating a stacking method in which a negative electrode, a positive electrode, and a porous polyethylene separator were stacked, and the electrode assembly was wrapped with the exterior film 20. Thereafter, a secondary battery in the form illustrated in FIG. 2 was manufactured using the cap 30 including the cover 50, the connector 40, and the terminal 60. At this time, sealing of the coupling portion 41 between the exterior film 20 and the connector 40 was performed at 240° C. and 0.6 MPa for 5 seconds.

### Examples 2 and 3, and Comparative Examples 1 to 3

Secondary batteries were manufactured in the same manner as in Example 1, except for the secondary battery specifications and sealing conditions described in Table 1.

### Experimental Example 1: Evaluation of Sealing Performance

For the secondary batteries manufactured as described above, external appearance was evaluated to determine whether the exterior film in the sealed region was damaged. Then, after the manufactured secondary battery was fully immersed in a water tank filled with water, air was injected into the interior of the secondary battery to check whether bubbles occurred at the sealed region to evaluate whether an unsealed portion occurred. In the evaluation results, “O” indicates the presence of damage or occurrence, and “X” indicates the absence thereof.

TABLE 1

| | | | Exterior | Unsealed |
|---|---|---|---|---|
| | Rg | MFR | film | portion |
| | (mm) | (g/10 min) | damage | occurrence |
| Example 1 | 0.1 | 8 | X | X |
| Example 2 | 1.0 | 12 | X | X |
| Example 3 | 1.5 | 6 | X | X |
| Comparative Example 1 | 0.05 | 12 | ◯ | X |
| Comparative Example 2 | 2.0 | 8 | X | ◯ |
| Comparative Example 3 | 1.5 | 2.2 | X | ◯ |

Referring to Table 1, in Examples 1 to 3 in which a radius of curvature between 0.1 mm and 1.5 mm was applied to the corner edge of the connector, it was confirmed that no film damage occurred and no unsealed portion was generated. However, in Comparative Example 1, the radius of curvature was too small, resulting in a sharp edge that caused damage to the exterior film. In Comparative Example 2, the radius of curvature was too large, and therefore, appropriate heating and pressing by sealing was not achieved at the edge portion, resulting in the generation of an unsealed portion. In addition, in Comparative Example 3, although the radius of curvature was within the desired range, an unsealed portion was generated due to failure to satisfy the melt flow rate requirement.

While the technology of the present disclosure has been described with reference to embodiments, it may be appreciated by one skilled in the art of the present disclosure or one having ordinary skill in the art of the present disclosure that various modifications and changes may be made to the various embodiments of the present disclosure without departing from the technical scope of the various embodiments of the present disclosure defined in the claims attached herewith. Therefore, the technical scope of the various embodiments of the present disclosure is not limited to the detailed descriptions of the invention herein, but should be determined by the scope defined in the claims.

What is claimed is:

1. A secondary battery comprising:
an electrode assembly extending in one direction;
an exterior film surrounding a portion of the electrode assembly; and
a cap surrounding a remaining portion of the electrode assembly,
wherein the cap includes:
a cover covering one side in an extending direction of the electrode assembly;
a connector provided on an outer surface of the cover and including a plurality of coupling portions that are coupled with the exterior film; and
a terminal at least partially exposed to an outside of the cover and electrically connected to the electrode assembly,
a corner edge is formed in a rounded manner at a junction where the plurality of coupling portions of the connector meet,
the corner edge has a radius of curvature Rg of about 0.1 mm to 1.5 mm, and include a first layer including a first resin that has an outer surface allowing coupling with an inner surface of the exterior film and an inner surface allowing coupling with the outer surface of the cover, and
the first resin includes a resin having a melt flow rate (MFR) at 230° C. of about 4 g/10 min to 14 g/10 min.

2. The secondary battery according to claim 1, wherein the first resin includes a resin selected from resins having a melting point (Tₘ) of about 135° C. to 150° C. and a melt flow rate (MFR) at 230° C. of about 4 g/10 min to 14 g/10 min.

3. The secondary battery according to claim 1, wherein the first resin includes a modified polyolefin-based resin.

4. The secondary battery according to claim 1, wherein each of the plurality of coupling portions of the connector includes:
a first layer including the first resin and allowing coupling with an outer surface of the cover; and
a second layer including a second resin stacked on an outer surface of the first layer and allowing coupling with the inner surface of the exterior film.

5. The secondary battery according to claim 4, wherein the second resin includes at least one selected from a resin having a melting point (Tₘ) of about 120° C. to 145° C.; a resin having a melt flow rate (MFR) at 230° C. of about 5 g/10 min to 18 g/10 min; and a resin having both a melting point (Tₘ) of about 120° C. to 145° C. and a melt flow rate (MFR) at 230° C. of about 5 g/10 min to 18 g/10 min.

6. The secondary battery according to claim 4, wherein the first resin and the second resin satisfy at least one of Formulas 1 and 2 below:
$${T}_{m 2} > {T}_{m 1} \qquad [ Formula 1 ]$$
wherein Tₘ₁ is a melting point of the first resin, and Tₘ₂ is a melting point of the second resin, in ° C.;
$$MFR 2 > MFR 1 \qquad [ Formula 2 ]$$
wherein MFR1 is a melt flow rate of the first resin, and MFR2 is a melt flow rate of the second resin, in g/10 min.

7. The secondary battery according to claim 4, wherein the first resin includes a modified polyolefin-based resin, and
the second resin includes an unoriented polyolefin-based resin.

8. The secondary battery according to claim 1, wherein an outer circumferential surface of the cover extends in a circumferential direction of the electrode assembly, and
the plurality of coupling portions are provided on the outer circumferential surface of the cover.

9. The secondary battery according to claim 1, wherein the cover includes:
a cover portion having an outward-facing surface facing an outside of the electrode assembly; and
an extension portion extending toward the electrode assembly from the cover portion, and
the plurality of coupling portions are provided on an outer surface of the extension portion.

10. The secondary battery according to claim 9, wherein the cover portion has a plate shape, and
the extension portion extends from an edge of the cover.

11. The secondary battery according to claim 9, wherein a radius of curvature of a cover edge formed at a position corresponding to the corner edge in the cover portion is less than or equal to the radius of curvature of the corner edge.

12. The secondary battery according to claim 1, wherein the exterior film has a predetermined flexibility to allow bending.

13. The secondary battery according to claim 1, wherein the connector includes a connecting portion provided on at least one surface of the outer surface of the cover, excluding the outer surface of the cover portion on which the plurality of coupling portions are provided.

14. The secondary battery according to claim 13, wherein the connecting portion of the connector includes a first layer including the first resin and having an outer surface allowing coupling with the inner surface of the exterior film and an inner surface allowing coupling with the outer surface of the cover portion.

15. The secondary battery according to claim 13, wherein the connecting portion of the connector includes:
a first layer including the first resin and allowing coupling with the outer surface of the cover portion; and
a second layer including the second resin stacked on an outer surface of the first layer and allowing coupling with the inner surface of the exterior film.

16. A battery pack comprising:
a secondary battery; and
a packaging configured to accommodate the secondary battery,
wherein the secondary battery includes:
an electrode assembly extending in one direction;
an exterior film surrounding a portion of the electrode assembly; and
a cap surrounding a remaining portion of the electrode assembly,
wherein the cap includes:
a cover covering one side in an extending direction of the electrode assembly;
a connector including a plurality of coupling portions provided on an outer surface of the cover and coupled with the exterior film; and
a terminal at least partially exposed to an outside of the cover and electrically connected to the electrode assembly,
a corner edge is formed in a rounded manner at a junction where the plurality of coupling portions of the connector meet, and
the corner edge has a radius of curvature Rg of about 0.1 mm to 1.5 mm.
